(19) United States
(12) Patent Application Publication
(10) Pub. No.: US 2011/0150034 A1
(43) Pub. Date: Jun. 23, 2011

(54) Sanitary clean in place thermowell

(75) Inventor: Scott Richard Breimon, Delano, MN (US)

(73) Assignee: THERMO FISHER SCIENTIFIC

(21) Appl. No.: 12/655,234

(22) Filed: Dec. 23, 2009

(51) Int. Cl. G01K 1/14

(52) U.S. Cl. 374/148; 29/428; 374/E01.018

(57) ABSTRACT

A resistance temperature detector (RTD) assembly (1) used for inserting a temperature sensor (18) into a pipe or containment vessel (62). The system (1) includes a connection head (2) that provides a path between a thermowell (10) containing the temperature sensor (18) and external data processing equipment. The thermowell (10) includes a shoulder region (26) that is shaped to accommodate an RTD seal (25) which provides a fluid impermeable clean in place barrier between the thermowell (10) and an interior region (64) of a fluid containing pipe or vessel (62) to which the thermowell is mounted. The RTD seal (25) is shaped and dimensioned to engage and abut various structural features of the shoulder region (26). The RTD seal (25) is formed as a single integrally molded article formed from a fluoroelastomer or peroxide cured nitrite rubber material.

### BACKGROUND OF THE INVENTION

1. Field of Invention

This invention pertains generally to the geld of temperature measuring probes and more particularly to the mounting of probes so as to permit access an interior region of a hollow structure such as a pipe.

2. Description of Prior Art

A thermowell is a device that protrudes unto a chamber, pipe, container or other enclosed structure to provide amass to do able materials within the structure. In particular, the thermowell permits insertion of a temperature sensor directly into the flowable material, allowing the temperature to be accurately measured in the region of interest rather than be inferred from an indirect measurement taken at some relatively displaced location. An exemplary embodiment a thermowell is disclosed in U.S. Pat. No. 6,599,012 entitled THERMOWELL ADAPTOR, issued to Gul on Jul. 29, 2003. The Gul disclosure is directed toward a thermowell installation in which frequent temperature probe insertion and removal operations are performed while various electrical leads are still connected to the probe being examined. The Gul device is primarily concerned with a thermowell structure that eliminates the need to rotate the temperature probe during installation or removal from the thereto all. A thermowell that permits temperature pram having different lengths to be accommodated by a thermowell having a fixed length is disclosed in U.S. Pat. No. 5,632,557, entitled MODULA TEMPERATURE SENSING APPARATUS, issued to Simons on May 27, 1997.

Another example of a temperature probe insertion structure is disclosed in U.S. Pat. No. 6,488,408, entitled TEMPERATURE PROBE MOUNTING DEVICE FOR HOT TUB SPA, issued to Laflamme et al. on Dec. 3, 2002. The Laflamme et al. device depicts a temperature probe inserted through the wan of a tub or vat which is subject only to atmospheric pressure. Since the probe may be subject to an outward force that would tend to dislodge the probe, an abutment is formed into the mounting structure that would limit a absolute longitudinal movement of the probe. An O-ring type of gasket is used to provide a fluid seal between the probe mount and the liquid contained within the tub.

An example of a thermowell suited for high temperature and pressure applications is disclosed in U.S. Pat. No. 6,485,175, entitled TEMPERATURE SENSING DEVICE FOR METERING FLUIDS, issued its Nimberger et al. on Nov. 26, 2002. The Nimberger et al. device addresses the problem of heat conduction between the pipe or other structure containing the fluid being analyzed and the thermowell device itself. In order address the problem presented by relatively high pressures and temperatures, close tolerance metallic parts are used throughout, while conventional O-rings are utilized in the embodiments intended for use in a lower pressure environment.

The foregoing devices not address the problem posed by the use of a thermowell in a materials processing environment in which sanitary conditions must be maintained. A need exists for a thermowell that permits cleaning within in such an environment without requiring either the removal of the thermowell or its associated sensor.

### SUMMARY OF THE INVENTION

The current invention is an improved apparatus to facilitate the insertion of a temperature sensor probe through the wall and into the interior of a structure such as a pipeline, conduit, vessel or shorter spool pipe section. The present invention includes a thermowell having an interior region formed to accept and retain a resistance temperature detector (RTD) which approximates a temperature value based on the current or voltage variation through an electrical conductor such as a platinum coil. Insofar as a variation in the absolute value of resistance through the conductor is based on the temperature of the conductor, the temperature to which the conductor is exposed may be calculated by solving Ohm's Law for any measured values of current and voltage. The thermowell permits the RTD to be inserted into as pipe or conduit such that the conductor resides at a point or region where the temperature of material flowing through the pipe may be accurately measured.

The thermowell is formed to include a shoulder surface that is relatively near the tip region of the inserted MID probe. When the thermowell is installed through the wall of a pipe or conduit, the shoulder surface resides within the material that is flowing within the pipe. The shoulder surface is contoured to provide various bearing surfaces which permit a sanitary fluid tight seal to be formed between the RTD probe, the thermowell and the wall of the structure through which the thermowell is mounted.

The present invention also includes a gasket or seal which is formed of a material approved by the U.S. Food and Drug Administration (FDA) for use in environments where edible products are being processed. Examples of such FDA approved materials include Resifluor 500, FDA Nikon 6780 and FDA NBR. The gasket includes an interior region formed to include channels and contours adapted to securely grasp mating structures on the thermowell shoulder surface.

In a preferred embodiment of the invention, the gasket includes a beveled external contour. In this embodiment, the gasket is tapered to relatively narrow region near the of the inserted RTD so as to minimize magnitude of any drag that may otherwise adversely affect flow velocity within the pipe. The exterior base of the gasket is substantially circular and is adapted to match the outside diameter of thermowell which it abuts. When the gasket is placed over and onto the shoulder structure of the thermowell, a sanitary fluid seal formed between the material flowing in the pipe and the interior regions of the thermowell. These and other advantages of the present invention will become apparent by referring to the accompanying drawings and the detailed description of the invention.

### BRIEF DESCRIPTION OF THE DRAWINGS

FIG. 1 is a perspective view of a resistance temperature detector assembly constructed according to the principles of the present invention;

FIG. 2 is a side elevation of the assembly depicted in FIG. 1 as mounted on an exemplary pipe, with a portion of the drawing shown in section along line 2-2;

FIG. 3 is a front elevation of the assembly depicted in FIG. 2, with a portion broken away to reveal interior details of the assembly;

FIG. 4 is an exploded view of the assembly depicted in FIG. 1;

FIG. 5 is a perspective view of the resistance temperature detector (RTD) thermowell depicted in FIG. 1;

FIG. 6 is a top plan view of the thermowell depicted in FIG. 5;

FIG. 7 is a sectional view taken along line 7-7 in FIG. 5;

FIG. 8 is a detail view of the region within the circle 8 as illustrated in FIG. 7;

FIG. 9 is a detail view of the region within the circle 9 as illustrated in FIG. 7;

FIG. 10 is a perspective view of the seal depicted in FIG. 1;

FIG. 11 is a sectional view taken along line 11-11 in FIG. 10 with the addition of a portion of the RTD thermowell of FIG. 5 depicted in order to illustrate the relationship of mating parts; and

FIG. 12 is a side elevation of a concentric reducer showing an a second exemplary pipe illustrating an alternate means for mounting the RTD assembly generally illustrated in FIG. 1.

### DETAILED DESCRIPTION OF THE PREFERRED EMBODIMENT

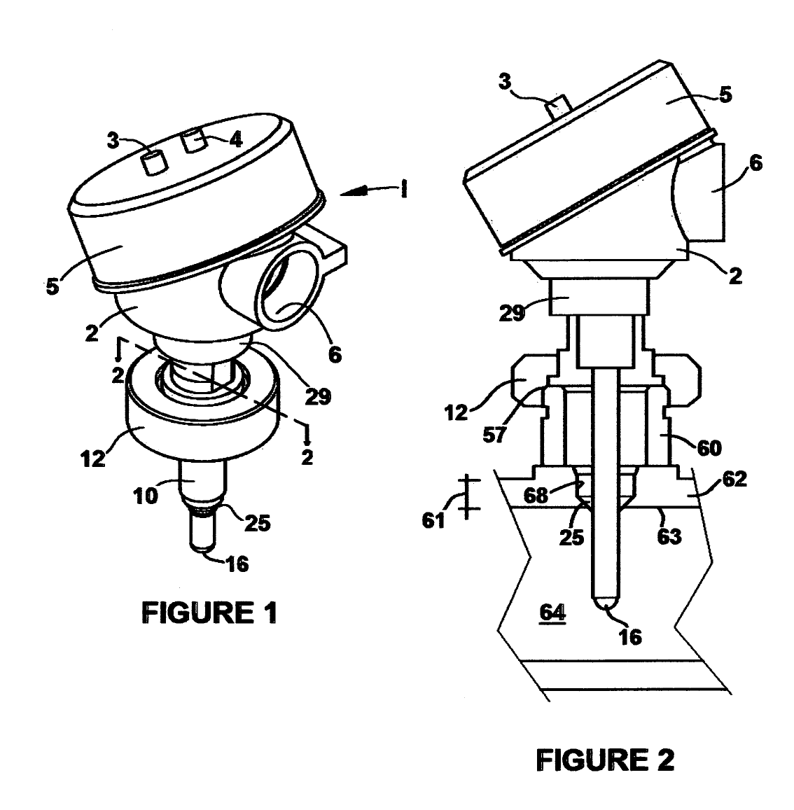

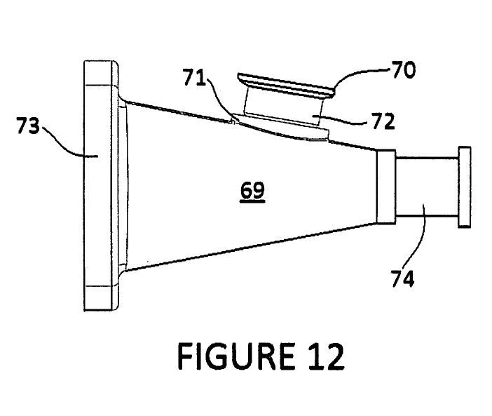

Referring to FIGS. 1 and 2, a resistance temperature detector (RTD) assembly constructed according to the principles of the present invention is shown generally at 1. The assembly 1 includes a connection head 2 of traditional and well known construction. Interior regions of the head 2 are covered by a removable cap 5. The connection head 2 also includes an access port 6 that permits data gathered within an RTD thermowell 10 to be transferred to a suitable receiving site. The RTD thermowell 10 is formed so as to have at generally cylindrical body that is affixed to a threaded fitting 60 formed on the exterior of a pipe or containment vessel 62. The RTD thermowell 10 is secured by means of an RTD nut 12 that is fitted over the top edge 57 of fitting 60 and tightened. An alternate apparatus for mounting the RTD thermowell 10 is illustrated in FIG. 12, which depicts, as an example, a concentric pipe reducer 69 having a relatively large diameter portion 73 and a relatively smaller diameter portion 74. A shoulder 71 is formed at the surface of the reducer 69 which supports an extension 72 that defines an critics extending through the surface of the reducer and into the interior of the reducer 69. On the outer end of end of extension 72 is weeded a sanitary fitting 70 known as a “tri-clamp” fitting which is attachable to fittings on associated piping. Tri-Clamp is a registered trademark of the Ladish Company. The RTD thermowell 10 may be constructed to include a suitable adapter that is dimensioned to mate with and be secured to the sanitary fitting 70.

The pipe 62 has a thickness 61 which defines an interior surface 63 of the pipe, the tip region 16 of the thermowell 10 thereby extending through an orifice that is formed in the pipe and lined with an RTD seal 25. The tip region 16 extends into the interior region 64 of the pipe so as to permit temperature measurements of materials flowing or residing within the pipe 62.

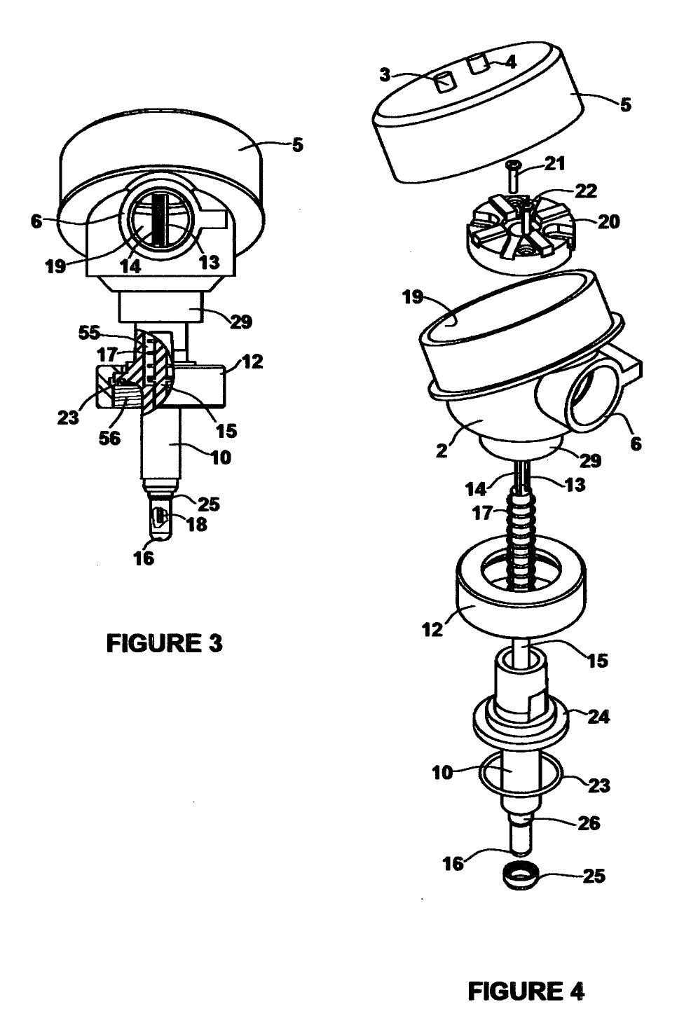

The relationship of the RTD thermowell 10 to the connection head 2 can be better appreciated with reference to FIG. 3, which reveals the sensor reads 13 and 14 that are associated with a temperature sensor 18 of conventional construction which is housed within the RTD thermowell 10. The reads 13 and 14 extend into a sheath 15 which is housed within thermowell cavity 55. The sheath 15 houses the temperature sensor portion 18 of the RTD probe in a region adjacent to the tip 16 of thermowell 10. A spring 17 biases the temperature sensor 18 lira a direction toward the tip 16. The RTD nut 12 contains threads 56 which permit the nut 12 be tightened by rotation onto a threaded fitting extending from a pipe or containment vessel to which the RTD thermowell 10 is mounted.

Additional features of the RTD assembly 1 may be appreciated with reference to FIG. 4. Two spaced apart studs or pillars 3 and 4 extend outwardly from the cap 5 to permit the application of a twisting force to the cap by means of a suitable toot. Beneath the cap 5 is an interior region 19 which houses a terminal strip or block 20 of conventional construction to which the temperature sensor leads 13 and 14 may be affixed by means of screws 21 and 22.

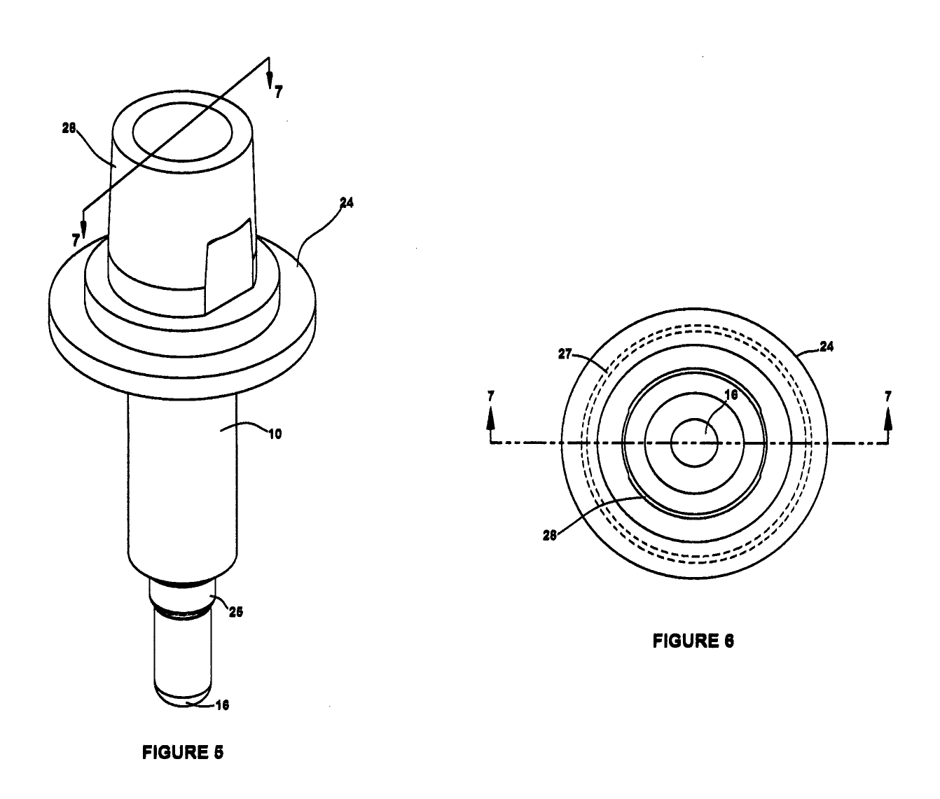

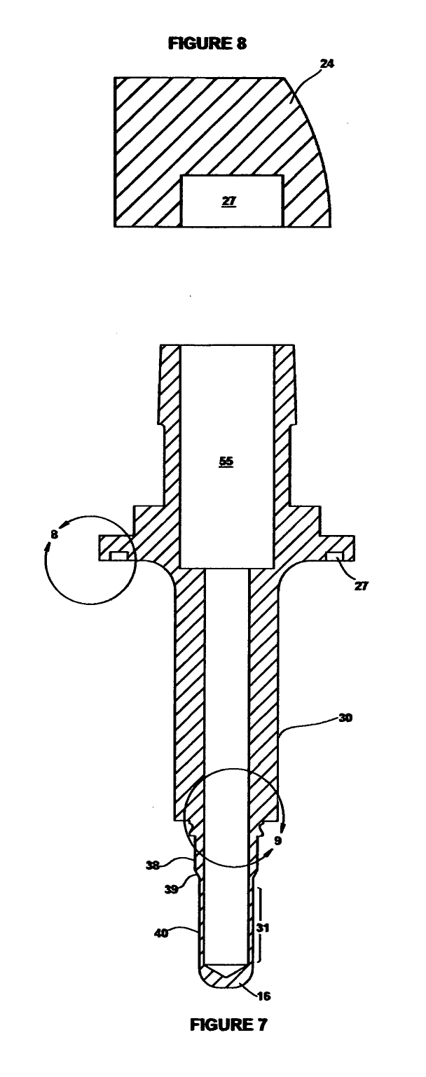

Referring also to FIGS. 5, 6 and 7 the RTD thermowell 10 is seen to include a tapered upper portion 28 that is adapted to fit within the lower receptacle 29 off the connector head 2. When mounted on a pipe, the lower flange 24 of the RTD thermowell abuts the pipe, the flange being an integral structural earned of the RTD thermowell 10. Referring also to FIG. 8, an O-ring 23 resides within a groove 27 that is formed on the lower surface 29 of the flange 24 in order to provide a fluid impermeable interface between an external surface of a pipe or containment vessel and the RTD thermowell assembly 1.

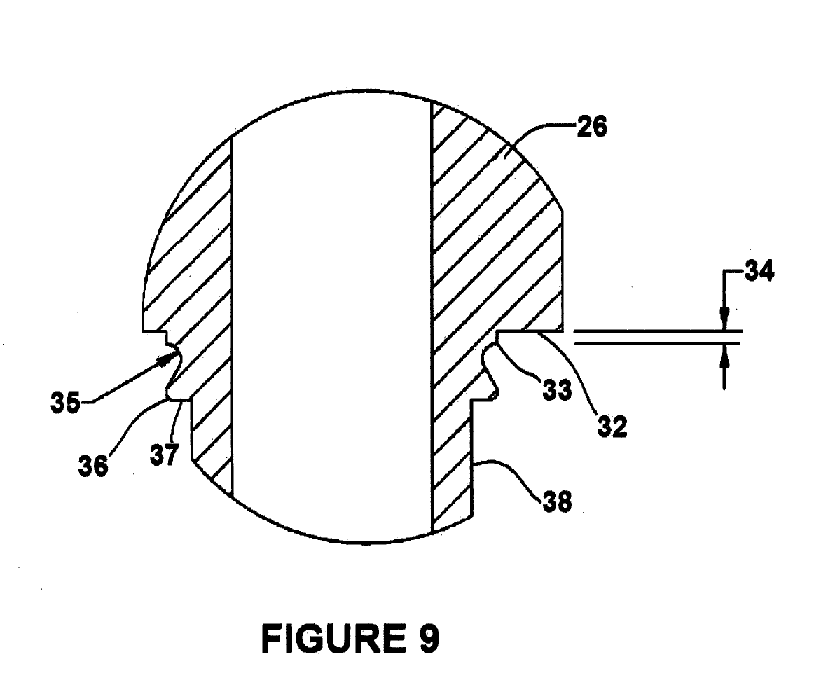

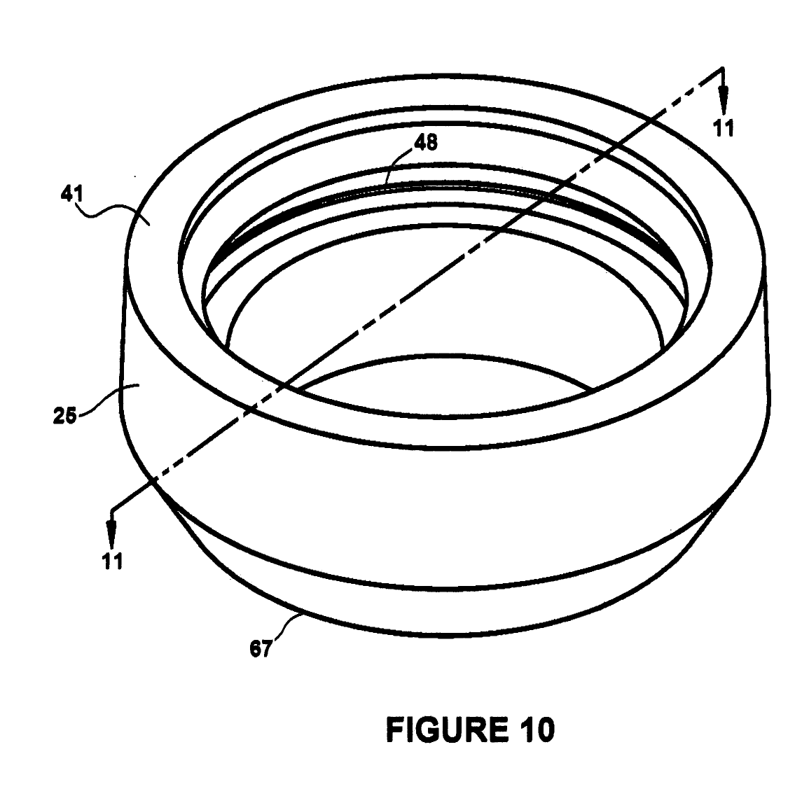

In order to created a sanitary clean in place interface between the thermowell 10 and the ambient environment, an RTD seal 25 is affixed to the shoulder 26 of the thermowell 10. FIG. 9 depicts the shoulder region 26 in MOSS detail. The shoulder region 26 provides a transition from the relatively wide portion 30 of the RTD thermowell 10 to the relatively narrow tip portion 31. The shoulder region 26 includes a relatively flat bearing surface 32 terminating at corner 33, the corner 33 being displaced a distance 34 from the bearing surface 32. The distance 34 is equal to approximately 0.40 millimeters. The corner 33 terminates at an inner radius 35 having a value approximately 0.50 millimeters. The inner radius 35 continues to an inclined protrusion or knob 36 having a radius of approximately 0.25 millimeters. The knob is formed to include a substantially planar bottom surface 37 which is substantially perpendicular to a substantially planar side surface 38. The side surface 38 terminates at the beveled surface 39 which adjoins the wall 40 that defines the outer surface of the relatively narrow tip portion 31.

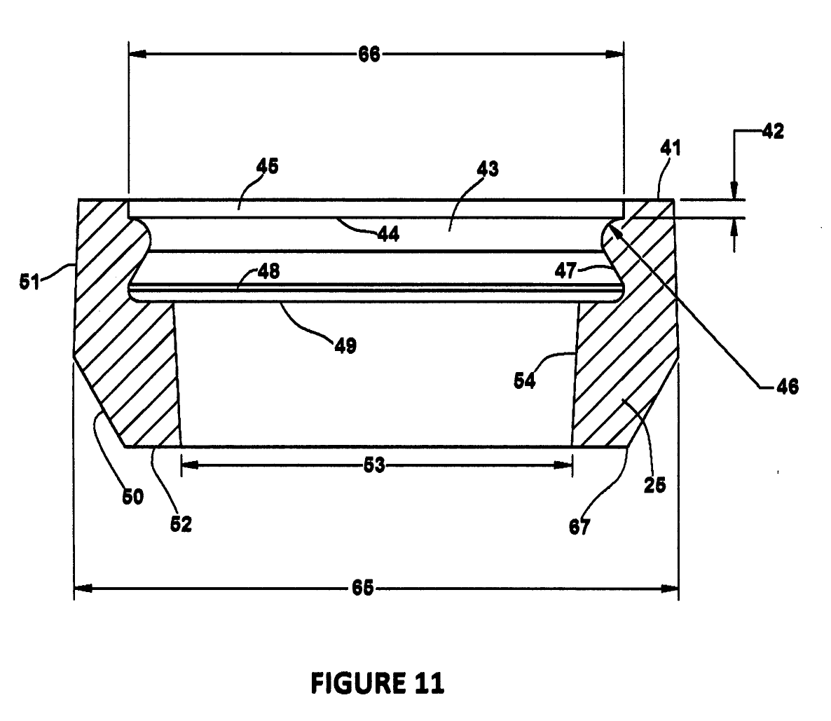

Referring also to FIGS. 10 and 11, the structure of the RTD seal 25 can be seen to include a substantially planar region 45 having an upper surface 41 that is adapted to abut the bearing surface 32. In a preferred embodiment the planar region 45 has a thickness 42 of approximately 0.40 millimeters. A curved mating surface 43 extends from the bottom surface 44 of planar region 45, the mating surface 43 having a radiused region 46 adapted to engage and abut the inner radius 35. The radiused region 46 in integrally formed with and transitions to an inclined surface 47. The surface 47 is compatibly shaped so as to engage and abut the protrusion 36.

A circumferential compression groove 48 is formed within the seal 25 so as to accommodate thermal expansions and contractions. A substantially planar shoulder 49 is formed within the seal 25 so as to abut the planar bottom surface 37 of the protrusion 36. The seal 25 includes a substantially vertical sidewall 51 that transitions to a beveled surface 50 that terminates at bottom wall 52. In a preferred embodiment, the relatively smallest diameter 53 formed by the tapered inner side wall 54 is approximately 8.83 millimeters. The diameter 65 defined by the vertical sidewall 51 is approximately 13.66 millimeters. The inner diameter 66 of the seal 25 is approximately 11.16 millimeters, which is substantially equal to the diameter defined by the bottom wall edge 67. In practice, orifice 68 in the pipe 62 is formed to have a diameter greater than bottom wall edge diameter 67 and less than the vertical sidewall diameter 65, thereby causing the beveled surface 50 of the RTD seal 25 to be biased toward the orifice sidewall and form a fluid tight seal between the relatively narrow tip portion 31 and the pipe orifice 68 when RTD nut 12 is fully tightened.

The RTD seal 25 is preferably formed of materials such as Resifluor 500, FDA Viton 6780 and FDA NBR. Resifluor 500 is a highly fluorinated fluoroelastomer having resistance to a broad range of chemicals and a maximum temperature rating of 170 degrees Celsius. Resifluor 500 is a product of Trelleborg Sealing Solutions, 181 Washington Street Conshohocken, Pa. 19428. Viton 6780 is a fluoroelastomer having a temperature resistance of approximately 205 degrees Celsius. Viton 6780 is available from Vicone, 320 Boulevard Industriel No. 7, Saint Eustache, Quebec, Canada J7R 5V3. FDA NBR is a peroxide cured nitrite rubber used in association with food processing applications that is available from numerous suppliers. The foregoing improvements and descriptions embodied in the present invention are by way of example only. Those skilled in the temperature sensing and food processing fields will appreciate that the foregoing features may be modified as appropriate for various specific applications without departing from the scope of the claims. The specific dimensions and materials used may of course be modified to include differing shapes, sizes, temperatures and chemicals to be encountered by a specific user of the foregoing technology. In particular, the tip length, inside diameter and outside diameter of thermowell 10 can be varied for different applications or RTD response times.

I claim:

1. A thermowell adapted to extend into a fluid containing vessel, comprising:
(a) a cavity formed within the thermowell, the cavity being adapted to house a resistance temperature detector;
(b) a connection head, the connection head being adapted to interconnect with the cavity so as to provide a path between the cavity and an external data processing location;
(c) a resistance temperature detector seal, the resistance temperature detector seal abutting an external surface of the thermowell and an internal surface of the fluid containing vessel so as to create a fluid impermeable barrier between fluid contained within the fluid containing vessel and a region external to the fluid containing vessel.

2. The thermowell according to claim 1, wherein the fluid containing vessel is a conduit adapted to transport a flowable material.

3. The thermowell according to claim 2, wherein the resistance temperature detector further comprises:
(a) a temperature sensor; and
(b) a plurality of electrical conductors extending from the temperature sensor and extending into an interior region of the connection head.

4. The thermowell according to claim 3, wherein the thermowell further comprises:
(a) a relatively narrow tip portion, the relatively narrow tip portion defining an end region of the cavity formed within the thermowell; and
(b) a tip region, the tip region defining an end of the relatively narrow tip portion, the temperature sensor residing within the tip region of the thermowell.

5. The thermowell according to claim 4, wherein the relatively narrow tip portion is formed so as to be substantially cylindrical.

6. A thermowell according to claim 5, wherein the thermowell further comprises:
(a) a relatively wide portion; and
(b) a shoulder region, the shoulder region residing between the relatively wide portion and the relatively narrow tip portion of the thermowell.

7. The thermowell according to claim 6, wherein the shoulder region further comprises:
(a) a relatively flat bearing surface, the relatively flat bearing surface being integrally formed with and defining an end extremity of the relatively wide portion;
(b) a corner, the corner defining a terminus of the relatively flat bearing surface;
(c) an inner radius, a first end of the inner radius extending from the corner,
(d) a knob, the knob being integrally formed with and adjoining a second end of the inner radius;
(e) a relatively planar bottom surface, the relatively planar bottom surface defining a lower surface of the knob;
(f) a side surface, the side surface being substantially perpendicular to and integrally formed with the relatively planar bottom surface; and
(g) a beveled surface, the beveled surface extending from the side surface to a wall, the wall defining the outer surface of the relatively narrow tip portion of the thermowell.

8. The thermowell of claim 7, wherein the resistance temperature detector seal is formed so as to substantially surround the shoulder region.

9. The thermowell of claim 8, wherein the resistance temperature detector seal further comprises a planar region having a substantially planar upper surface and a substantially planar bottom surface, the substantially planar upper surface being adapted to abut and sealingly engage the relatively flat surface of the shoulder region.

10. The thermowell of claim 9, wherein the resistance temperature detector seal further comprises a curved mating surface, the curved mating surface extending from the substantially planar bottom surface of the planar region, the curved mating surface being formed to include a radiused region adapted to engage and abut the inner radius of the shoulder region.

11. The thermowell of claim 10, wherein the radiused region of the resistance temperature detector seal is integrally formed with and transitions to an inclined surface, the inclined surface being compatibly shaped so as to engage and abut the knob of the shoulder region.

12. A thermowell mounting system providing for the cleaning in place of a thermowell affixed to a pipe, comprising:
(a) a thermowell, the thermowell comprising:
(i) a cavity adapted to house a resistance temperature detector; and
(ii) a generally cylindrical body surrounding the cavity and including a tip region, at least a portion of the tip region passing through an orifice formed in the pipe and extending into an interior region of the pipe; and
(b) a fluoroelastomeric seal, the fluoroelastomeric seal surrounding a portion of the generally cylindrical body so as to form a fluid impermeable seal at the orifice formed in the pipe;

13. The thermowell mounting system of claim 12, wherein the generally cylindrical body of the thermowell further comprises:
(a) an upper portion having a relatively larger diameter;
(b) a lower portion having a relatively smaller diameter, the tip region residing in the lower portion; and
(c) a shoulder region, the shoulder region being integrally formed with and residing between the upper portion and the lower portion.

14. The thermowell mounting system of claim 13, wherein the fluoroelastomeric seal is mounted so as to surround and abut the shoulder region, the fluoroelastomeric seal filling any void region existing between the orifice in the pipe and the lower portion of the thermowell.

15. The thermowell mounting system of claim 14, the fluoroelastomeric seal further comprising:
(a) a substantially vertical sidewall; and
(b) a beveled surface, the beveled surface being integrally formed with and extending inwardly from the substantially vertical sidewall, the beveled surface engaging a boundary of the orifice in the pipe when the thermowell is affixed to the pipe.

16. The thermowell mounting system of claim 15, wherein the shoulder region comprises a relatively flat bearing surface, the relatively flat bearing surface being integrally formed with and defining an end extremity of the upper portion of the thermowell, the relatively flat bearing surface being adapted to engage and abut the fluoroelastomeric seal so as to form a fluid impermeable interface.

17. A method of mounting a thermowell to a pipe having an exterior surface and an interior surface, wherein both pipe surfaces are penetrated by a single orifice having a continuous circumferential sidewall, comprising the steps of
(a) inserting a resistance temperature detector into the thermowell;
(b) inserting the thermowell through the orifice a distance sufficient to permit the resistance temperature detector to sense a temperature of a material within the pipe; and
(c) placing a fluoroelastomeric seal on at least a portion of the thermowell that extends into the pipe so as to form a fluid impermeable barrier between the interior surface and the exterior surface of the pipe.

18. The method of claim 17, further comprising the steps of
(a) forming a shoulder region on the thermowell in a region adjacent to the pipe; and
(b) forming an interior region of the fluoroelastomeric seal to include mating surfaces adapted to continuously abut and engage the shoulder region of the thermowell.

19. The method of claim 18, further comprising the steps of
(a) forming the fluoroelastomeric seal to include a beveled surface; and
(b) biasing the beveled surface toward the circumferential sideman of the single orifice so as to form a fluid impermeable barrier between an interior region and an exterior region of the orifice.

20. The method of claim 19, further comprising the step of forming a circumferential groove on an interior surface of the fluoroelastomeric seal in order to accommodate ambient environmental conditions encountered by the fluoroelastomeric seal.
